(19) United States
(12) Patent Application Publication
(10) Pub. No.: US 2007/0288300 A1
(43) Pub. Date: Dec. 13, 2007

(54) Use of physical and virtual composite prototypes to reduce product development cycle time

(76) Inventors: Thomas William VanDenBogart, Slinger, WI (US); Adrienne Rae Loyd, Neenah, WI (US); Steven Anthony Moore, Appleton, WI (US); Matthew Karl Gruttadauria, Yarmouth Port, MA (US); Michael Joseph Nelson, Neenah, WI (US); Cerita Diane Bethea, Woodstock, GA (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/638,947

(22) Filed: Dec. 14, 2006

Related U.S. Application Data
(60) Provisional application No. 60/813,438, filed on Jun. 13, 2006.

(51) Int. Cl. G06F 17/30

(52) U.S. Cl. 705/10

(57) ABSTRACT

A method for rapidly producing a prototype includes the steps of conducting an interview of a participant in a product development study; presenting an item for review; providing physical sets of alternatives for components of the item; eliciting preference values for the alternatives from the participant; inputting the preference values into a computer software program; producing a virtual ideal item based on the preference values using the computer software program; and presenting the virtual ideal item to the participant.

The present application claims the benefit of the prior, co-pending U.S. Provisional Patent Application Ser. No. 60/813,438 entitled THE USE OF PHYSICAL AND VIRTUAL COMPOSITE PROTOTYPES TO REDUCE PRODUCT DEVELOPMENT CYCLE TIME by T. VanDenBogart et al., which was filed Jun. 13, 2006 (attorney docket No. 21885), the entire disclosure of which is incorporated herein by reference in a manner that is consistent herewith.

### BACKGROUND

The process of designing, developing and manufacturing a new product, or making improvements to existing products, presents many challenges to businesses to bring concepts to market quickly while maintaining low cost and high quality. In today's highly competitive industries, businesses require information to address many problems that arise because of the complexity of new products, the reality of global production and the changing nature of competition. Since new concepts need to be brought to market very quickly in order to remain competitive, the traditional learning curve formerly associated with product development is eroding, creating the need for better controlled product release and understanding of cost impacts for designs early in the design process.

Traditional market research methods make up a large part of an item's development cycle time. Time to market can often influence success in that market; therefore reducing development time is an important emphasis in business today. Currently, a typical product development and marketing cycle involves four steps and is often a cyclical process of several iterations: (1) the development of concept statements, (2) the combination of these statements into some smaller number of actual concepts, (3) the application of these concepts into usable prototypes, and (4) the measurement of customer interest versus a control. Therefore, there is a need to leverage current technology to reduce the consumer testing portion of this cycle time. There is also a need to reduce the steps involved with a typical product development and marketing cycle.

In addition, consumers generally observe products, packaging and physical displays of products, while they inspect images, read words, listen to music, consider colors and/or engage in other reviewing activities, until they find the specific product most suitable for their needs, interests or tastes. This results in consumers exercising discriminating judgments and mental processes to make selections. Therefore, there is a further need for a product development and marketing method which also takes into account the degree of consumer preference toward particular item features.

### SUMMARY

In response to the needs discussed above, a method for rapidly producing prototypes is provided that significantly reduces the consumer testing portion of the product development and marketing cycle. The method also reduces the steps involved with the typical product development and marketing cycle. The method also takes into account the degree of preference of consumers toward particular item features.

In one aspect of the invention, the method comprises the steps of: conducting an interview of a participant in a product development study; presenting an item for review; providing physical sets of alternatives for components of the item; eliciting preference values for the alternatives from the participant; inputting the preference values into a computer software program; producing a virtual ideal item based on the preference values using the computer software program; and presenting the virtual ideal item to the participant.

In some aspects, the invention further comprises the step of defining the ideal item design using computer programming to pool participant choices to determine statistical implications. In another aspect, the invention further comprises the step of determining the importance of each element of the entire design process. In still another aspect, the invention further comprises the step of eliciting emotional feedback from the participants.

In some aspects of the invention, virtual reality may be utilized. For example, virtual reality may be utilized to present an item for review. In other aspects, virtual reality may be utilized to help participants review alternatives for components. In yet other aspects, virtual reality may be utilized to produce the virtual ideal item. In still other aspects, virtual reality may be utilized to present the virtual ideal item to the participant.

In some aspects of the invention, the item is modified and displayed to the participant after each decision is made. In other aspects, a physical version of the virtual ideal item is constructed. For example, the physical version can be produced using a rapid prototyping system.

In some aspects of the invention, the virtual ideal item can be compared to the participant's usual item. In other aspects, a number of mutations to the item may be generated. In still other aspects, alternatives for the item can be proposed on the fly (i.e., real-time).

In some aspects, follow-up questions may be asked of the participant. In other aspects, non-verbal feedback may be obtained from the participant. In some features, the non-verbal feedback can be obtained by using a biomonitor.

In some aspects, the preference values can be quantitatively correlates with corresponding predetermined optimum applicability values using a correlation algorithm to calculate an overall or average rating for each alternative. In some features, the algorithm can include scaling factors.

In some aspects, the participant can make modifications to the item. In other aspects, the participant is pre-screened. In still other aspects, the participant is placed into a group, based on pre-determined criteria to obtain particular information. In yet other aspects, the invention includes computerized systems with multiple participants joined by a network and multimedia marketing research systems.

Numerous other features and advantages of the present invention will appear from the following description. In the description, reference is made to exemplary embodiments of the invention. Such embodiments do not represent the full scope of the invention. Reference should therefore be made to the claims herein for interpreting the full scope of the invention. In the interest of brevity and conciseness, any ranges of values set forth in this specification contemplate all values within the range and are to be construed as support for claims reciting any sub-ranges having endpoints which are real number values within the specified range in question.

### FIGURES

The foregoing and other features, aspects and advantages of the present invention will become better understood with regard to the following description, appended claims and accompanying drawings where:

FIG. 1 is a flow diagram showing the functional requirements for implementing the product development and/or marketing method according to the present invention;

FIG. 2 is an exemplary interview outline according to the method of the present invention;

FIG. 3 is a screen illustrating an exemplary logic filter used for rapidly building a virtual prototype of a tampon;

FIG. 4 is a screen illustrating a computer display of an exemplary HTML page illustrating the virtual prototype of FIG. 3; and

FIG. 5 is a virtual prototype separated into components.

Repeated use of reference characters in the present specification and drawings is intended to represent the same or analogous features or elements of the present invention.

### DEFINITIONS

It should be noted that, when employed in the present disclosure, the terms “comprises,” “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

The term “component prototype” refers to components or features of an item (i.e. portions of the whole unit) that are evaluated, ranked and/or rated by a participant in a product development and/or marketing study of the present invention.

The terms “consumer,” “participant” and derivatives thereof are used interchangeably to refer to at least one person participating in the method of the present invention. This may include, but is not limited to, customers, choosers of items, users of items, distributors and sellers of items, suppliers of items, and/or any other business party such as contract manufacturers, subsidiaries, licensees, partners, consultants, and the like.

The term “item” refers to an objective, comparative or end result of a product development and marketing effort according to the present invention. An item represents a whole unit, as compared to a component which represents only a portion of the whole unit. Such “items” include, but are not limited to, products, packagings, and the like. By way of example, an item, as used herein, may be in the form of a control item, a participant's usual item, a competitive item, a conceptual item, a participant's ideal item, and the like. The term “ideal item” refers to an item which incorporates a participant's evaluation, ranking and/or rating feedback, such as obtained during a product development and/or research study.

The term “item prototype” refers to a virtual and/or physical assimilated item (i.e., whole unit) which results from the evaluation, ranking and/or rating of component prototypes, and optionally other feedback, from participants in a product development and/or marketing study of the present invention.

These terms may be defined with additional language in the remaining portions of the specification.

### DETAILED DESCRIPTION

This invention provides a method for rapidly building a prototype of an item as part of a product development and/or marketing process. The method allows consumers who participate in a market research study to physically and/or virtually view an existing item, as defined above. The participants can then build an “ideal” item by viewing and/or handling physical components of that item, and rating the alternatives within each of the component groups to demonstrate their preferences on a ranked and rated basis. The “ranking” function provides a measurement of a participant's preference, and the “rating” function provides a measurement of intensity of a participant's interest.

The method of the present invention allows participating consumers to express their preferences both qualitatively and quantitatively through interviews and hands-on demonstrations, as well as through a ranking and rating system. Each participant's preferences are then incorporated into a computer software program which quickly produces a three-dimensional virtual representation of the participant's “ideal” item which incorporates the participant's preferences. The virtual item is then presented to the participant for their review. In some aspects, a physical prototype can alternatively, or additionally, be constructed and presented to the participant. The resulting ideal item allows participating consumers to make judgments relative to current and/or conceptual products. Further modifications to the virtual item can also be made while the participant is present at the study. This provides valuable and easily compiled insight into potential product modifications, which in turn reduces steps and accelerates the product development and marketing cycle, thereby increasing overall speed to market. In addition, the method of the present invention helps to quickly determine whether improvements or conceptual options are sufficiently compelling to consumers to be worthy of investment.

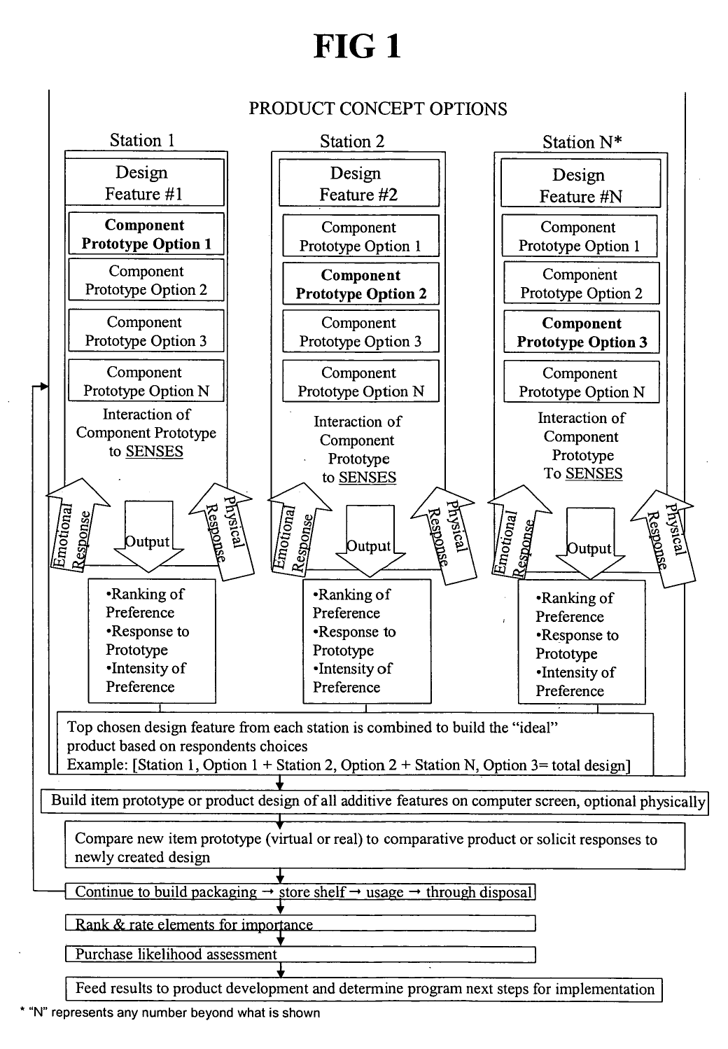

To obtain a better understanding of the method of the present invention, attention is directed to FIG. 1, which shows a flow diagram demonstrating the functional requirements for implementing the method of the present invention. The flow diagram demonstrates how component prototype stations help participants address and/or evaluate design feature options (i.e., component prototypes) one by one to determine preferred options. Physical and emotional responses to the prototypes result in an output response of ranking and intensity (i.e., rating) of preference to the prototypes for any given design feature. Top component prototype choices for each design feature are combined to build a new total design solution. This newly created item prototype can be created virtually on a computer and can optionally be physically constructed, such as on a portable rapid prototype machine, and then shared with the participant to elicit a response (emotional and/or physical) when compared to a control. In some aspects, the control can be the participant's usual product. In other aspects, the control can be a current product. In still other aspects, the control may be created specifically for a particular study.

A traditional product development and/or marketing cycle typically involves four phases: (1) the development of concept statements, (2) the combination of these statements into some smaller number of actual concepts, (3) the application of these concepts into usable prototypes, and (4) the measurement of customer interest versus a control. This often results in conducting numerous studies in sequence before focusing on a single improved or new item, thus costing a great deal of time and money, and often requiring hundreds, or even thousands, of physical item prototypes. In contrast, utilizing the method described herein, the traditional product development cycle is basically reduced to two phases: (1) creating physical component alternatives representing various concept statements, and (2) a single consumer test study which measures consumer interest in these concepts, the participant's ideal combination of these concepts for discussion, as well as sensory and emotional responses. This results in producing very few physical prototypes while potentially conducting only one study session, thus saving substantial time and resources.

In concert with the two aforementioned product development cycle compressed steps is the inclusion of emotional impact indices and measurements. These emotive benefits are based on insights obtained from exploratory research and are reflected in the physical prototypes that represent various concept statements. This is accomplished by determining which functional characteristics of a product elicit or influence a particular emotive response, and then mapping them onto proposed concepts and prototypes.

For example, in the case of a tampon, prototypes could be developed that best express the feeling of being “pampered.” This determination can be made based on exploratory research on the emotional needs of the particular target group for this item. In other aspects, a different presentation of components may be needed to convey a feeling of “empowerment,” or “confidence.” In other words, research aids can assist in focusing the concept statements and prototypes to deliver certain emotive responses.

Embedded in the second step of the product development and/or marketing cycle (i.e., consumer test study) is a measurement of the degree to which the product elicits pleasant versus unpleasant emotions for both the control item and a participant's ideal item. In combination with the sight and handling component evaluation, this measurement allows for a comparison of functional and emotional features that drive the overall perception of the item. Inclusion of such a dual framework facilitates the reduction in product development cycle time by ensuring that emotion-based insights are mapped to product solutions in a one-to-one correspondence. In addition, it also increases the likelihood of making an emotional connection with the consumer.

The building of sample groups of participants and structuring of interviews can be accomplished by any of various techniques known in the marketing or behavioral sciences. Once selected, a participant can be presented with selection criteria options for one or more components of the item being evaluated. Evaluations can be both qualitative and quantitative in nature.

Using various qualitative interviewing techniques known in the art, participants are asked to express their thoughts and feelings associated with an item. These thoughts and feelings include functional and aesthetic attributes of the item, for example, as well as the motivating factors that influence perception of the item. The associations that participants make between these functional and emotional attributes may vary by demographic and psychographic differences, for example. Such qualitative data serves to inform product developers of the scope of solutions available for subsequent prototyping.

Various quantitative techniques can also be utilized to evaluate and rank various components and embodiments of an item. For example, one component of a packaging design, such as a graphics scheme, may be presented with five alternatives. Each alternative is then ranked and rated, such as on a scale of one to one-hundred, to provide preference values. This not only demonstrates how strongly a participant feels about one alternative over another, but also indicates how important a particular component is to the participant. For example, if all alternatives are rated low, the particular feature may be viewed as not important, whereas a high rating of even one alternative could indicate that a particular component has high importance to the participant.

The values for each set of components are then provided to a facilitator to be entered into a computer software program (or they can be entered into the computer directly by the participant) and are stored in a data file. These preference values are assigned to application scales where such values correspond to the selection criteria options chosen by the participant. The selection criteria options chosen by the participant need not correspond identically with particular application scales. Instead, the selection criteria options chosen by the customer may be translated into either one or a plurality of preference values on one or more associated application scales for each component.

The preference values can then be processed through a logic filter to begin building a virtual prototype item for viewing by the participant. In some aspects of the invention, the virtual prototype is modified and displayed (i.e., providing an updated version) to the participant after each decision is made. Such values can later be changed if desired based on further feedback from the participant. The process continues until a virtual “ideal” item is presented to the participant. In some aspects, a physical representation of the participant's ideal item may optionally be constructed. In further aspects, a representation of the participant's “usual” item (virtual and/or physical) can also be presented to provide a side-by-side comparison. The virtual and/or physical ideal item can then be compared to other items to obtain additional feedback.

If desired, the “ideal” item at this point may then be subject to additional validation and system-wide optimization or harmonization steps. Recognizing that optimized components may not necessarily lead to an optimized whole, particularly when interactions between components contribute to overall consumer preference or product performance, the results of piece-wise optimization procedures may need to be modified to take advantage of interactions and synergies. For example, optimization of individual components of an item may lead to clashes in color or missed opportunities for harmonizing the appearance of various components. An automated system can consider two different approaches, both of which may be executed in the validation phase. One approach is to apply predetermined heuristics to modify the system, such as a rule to propose that all colors be compatible, or that similar textures be applied to textured portions of the system, or other rules applicable to a given product. Modifications can then be made automatically and several modified versions of the product can be presented for comparison with the previous ideal item to see if a modified version is more preferred than the previous “ideal” result. If so, further exploration may be needed to optimize the system. A second approach is to automatically generate a number of “mutations” in which attributes of the final product are generated and displayed to determine if a “mutation” is preferred. These forced perturbations away from the previous solution may help consumers recognize interactions or other benefits not easily identified through a part-by-part optimization scheme, but could require numerous trials to identify improvements. The combination of “intelligent” modifications based on logical rules coupled with more random modifications of attributes may lead to improved solution sets in the end.

A third approach can include manual changes, in which a designer or product developer proposes alternatives on the fly (i.e., real-time), to achieve a more harmonious overall design or improved functionality or marketability. The proposed alternatives can then be evaluated by the participants to determine if they may be superior, though the alternatives will generally incorporate at least some of the component selections made by the participants. In any of these schemes, the scope of changes made for participants to consider may be system-wide or may affect only a limited number of subsets of the system.

The participant may be asked follow-up questions regarding the ideal item. Such questions may include, but are not limited to, whether the participant would purchase the ideal item, how much the participant would pay for the item, and the like. In addition, to obtain verbalized responses from the participant, non-verbal feedback may also be obtained. For example, physical responses of the participant to the finalized product, and optionally to alternative or competitive products, may be examined to better understand the participant's emotional response to the products.

In some aspects, the participant need not know that such monitoring is occurring. For example, a camera may record information about the facial response of a participant, which can then be analyzed for subtle cues (eye motion, action of various muscles in the face, etc.) to determine the appearance of the product. Principles of computerized facial analysis are discussed by A. Sarrafzadeh et al., “Facial Expression Analysis for Estimating Learner's Emotional State in Intelligent Tutoring Systems,” Third IEEE International Conference on Advanced Learning Technologies (ICALT'03), 2003, p. 336 (see http://doi.ieeecomputersociety.org/10.1109/ICALT.2003.1215111). In other aspects, biomonitors can be used to examine heat rate, breathing, and other factors that may provide subtle information about emotional responses. The participant may also be offered an opportunity to buy the product at the end of the study (even though it may not yet be available publicly) or to place an order for a future delivery to determine one measure of willingness to make a purchase.

In some aspects, a correlation algorithm can be utilized to quantitatively correlate each of the preference values with corresponding predetermined optimum applicability values to calculate an overall or average rating for each of the component prototype designs. A group of identified components is displayed for the participant based on the average preference ratings for those identified feature designs. This can help provide insight as to the strength of new design based on scores. In some aspects, the scores could be cross compared from study to study to obtain a read on the level of impact, often called a “WOW factor.”

In some aspects, the correlation algorithm can quantitatively correlate the participant's preference values with corresponding predetermined optimum applicability values to calculate an overall or average suitability rating for each of the component prototype data files in storage by first calculating the differences between each pair of the customer preference values and the corresponding predetermined optimum applicability values for each of the application scales in which a corresponding pair exists. Then each of the calculated differences can be squared, because the differences between the participant's preference values and the corresponding predetermined optimum applicability values may be calculated as either positive or negative values. It will also result in an exponential effect on the magnitudes of the differences. The squared differences can then be summed, and the square root of the summed squared differences can be calculated to obtain a gross preference rating for each component design. This gross preference rating can then be averaged by the number of calculated differences to obtain the average preference rating for each product design.

In other aspects, the operation of the algorithm may be modified by the introduction of scaling factors for each of the application scales by which each of the calculated differences on a given scale is multiplied prior to squaring the calculated differences. These scaling factors used to multiply the calculated differences may be used to control the magnitude of exponential effect associated with calculated differences on any scale. Further modification of the algorithm may include the introduction of weighting factors by which each of the squared differences is multiplied prior to summing the squared differences. These weighting factors may be used to control the impact of any scale on the overall preference calculations.

In still other aspects, a predetermined minimum threshold value may be established for the average preference rating. If the above calculations result in an average preference rating which does not meet the minimum threshold value, the differences between each pair of a participant's preference values and the corresponding predetermined optimum applicability values may be re-calculated using all but a select group of application scales in which a corresponding pair exists. In this manner, application scales which may disproportionately skew the average preference rating may be ignored when carrying out the required calculations. In effect, the algorithm can be constructed to ignore successively those application scales considered to be least important to customer interests while searching the product files to find potentially suitable items.

In some aspects, the method of the present invention can elicit the participant to select one of the identified component prototype designs and verify the selection, and then display the selected design. The selected design may then be modified by the participant. The selected or modified component prototype design can then be dispensed to the participant in the form of a virtual display and/or a physical product, and can additionally be stored on a suitable storage medium for later delivery and comparison of future design options.

As referenced above, in some aspects, virtual reality technology can also be incorporated into the method of the present invention. Virtual reality tools can provide enhanced three-dimensional (3-D) capability and can serve as strong analytical and presentation tools. For example, consumers or other participants can interact with virtual reality systems such as VR pods, VR caves, multi-wall display systems, VR headsets, hybrid goggles, head mounted displays (HMDs), and the like. By way of example, VR tools suitable for use in some aspects of the present invention can include the pods and other hardware systems and software systems, such as those marketed by VisionaiR 3D (having a place of business in Tilburg, The Netherlands); display systems, such as those available from Visbox, Inc. (having a place of business in Champaign, Ill., U.S.A.); head-mounted displays, such as those available from Cybermind (having a place of business in Maastricht, The Netherlands) such as the VISETTE PRO; and other devices, such as those available from Tek Gear (having a place of business in Winnipeg, Canada).

In addition to those described above, other systems and methodologies for evaluating consumer preferences can be used in the present invention, including computerized systems with multiple participants joined by a network and multimedia marketing research systems for optimizing product properties. Exemplary systems and methodologies include those of US 2002/015211A1, published Oct. 17, 2002 by B. Stewart et al. and US 2003/0126010A1, published Jul. 3, 2003 by P. A. Levitsky; each of which is incorporated herein by reference in a manner that is consistent herewith. With such systems, multiple participants may be joined in a network, each capable of interacting with a proposed product in simulated 3-D space. For example, participants wearing head mounted display systems and instrumented gloves may be able to see the virtual object in three dimensions and move its virtual representation using hand motions. Alternative product forms may be displayed to allow participants to compare the 3-D representations of the items and make selections between various alternatives.

In some aspects of the invention, finalized product selections or sets of preferred product forms can be generated using rapid prototyping systems to quickly allow the participants to see and feel actual three-dimensional objects to determine if preferences change when going from a virtual to a physical representation of the product. Suitable prototyping systems can be selected from any known in the art, including stereolithography tools such as those available from Acu-Cast Technologies (having a place of business in Lawrenceburg, Tenn., U.S.A.) and Fused Deposition Modeling (FDM) technology such as the FDM VANTAGE series available from Stratasys, Inc. (having a place of business in Eden Prairie, Minn., U.S.A.). Other known technologies that can be adapted for the present invention include Laminated Object Manufacturing (LOM) systems such as those available from 3D Systems, Inc. (having a place of business in Valencia, Calif., U.S.A.); Solid Imager Stereolithography available from Aaroflex, Inc. (having a place of business in Fairfax, Va., U.S.A.); Selective Laser Sintering (SLS); Solid Ground Curing available from Cubital (having a place of business in Raanana, Israel); Paper Lamination Technology available from KIRA Corporation (having a place of business in Aichi, Japan); Direct Shell Production Casting available from Soligen Inc. (having a place of business in Northridge, Calif., U.S.A.); Laser Engineered Net Shaping (LENS) available from Optomec Design Company (having a place of business in Albuquerque, N.Mex., U.S.A.); Digital Light Processing (DLP) available from Envision Technologies GmbH (having a place of business in Marl, Germany); Ballistic Particle Manufacturing (BPM); and 3D printing (3DP) such as printing with a Z810 Ink Jet Printer available from Z Corporation (having a place of business in Burlington, Mass., U.S.A., a subsidiary of Contex of Denmark). Additional information regarding the hardware and applications of rapid prototyping technology include those in U.S. Pat. Nos. 6,406,658 and 6,495,794, each of which is incorporated herein by reference in a manner that is consistent herewith.

The method of the present invention can be applied to various aspects of product development and marketing functions. Some examples include, but are not limited to, products, product features, product packaging, and the like. In some aspects, parameters may be considered which include, but are not limited to, product design, materials, aesthetics, ergonomics, colors, shapes, scents, feel, sounds, usefulness, performance, price, brand names, package count, package design, purchase intent, sensory perceptions, emotional cues, and the like. In some aspects, the method of the present invention may be applied to a business's existing items and/or competitive items, as well as past items and conceptual items.

Any number of participants may be included in a study according to the method of the present invention. For example, in one particular aspect, the study included 200 participants, which in some aspects may be viewed as being efficient for appropriate statistical analysis. In some aspects, participants may be pre-screened based on certain criteria. In other aspects, participants may be placed into groups based on pre-determined criteria to obtain particular information. For example, such criteria may include, but is not limited to, demographics including as work status, income, marital status, family size; social factors; brand users; and the like.

The present invention may be better understood with reference to the following examples.

### EXAMPLES

### Example 1

A product development and marketing study was conducted regarding an improved tampon. More specifically, a sight and handling study, which is a type of focus group that allows consumers to interact directly with various product samples and express their preferences, was held to determine how consumers felt about several potential tampon product improvements. The study session utilized 200 participants and focused on tampon applicator and pouch (wrapper) improvements.

### Description of Qualitative Evaluations

Qualified women were recruited for a specific appointment at a qualitative interview facility with a two-way mirror. A moderator conducted an in-depth one-on-one interview with each woman.

During that interview, each woman viewed and discussed the design options being considered for either a conceptual item or for an improvement on an existing item. Design option sets (i.e., component prototypes) were presented one at a time. For each set, the in-depth interview explored perceptions and reasons for perceptions, preferences and reasons for preferences, and anticipated distinctiveness and functionality of each of the appealing options.

### Description of Quantitative Evaluations

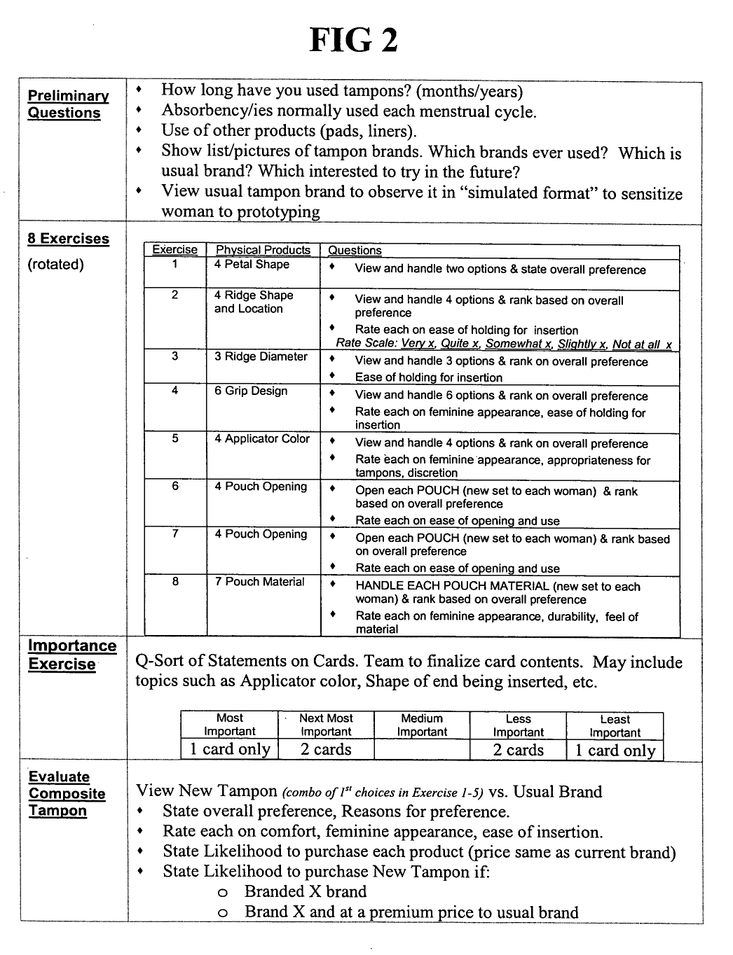

Interviews of the qualified women were conducted one-on-one with a trained interviewer. A detailed description of the interview flow can be seen in FIG. 2.

Before the interview began, respondents were handed a current tampon and a conceptual tampon to feel the difference to neutralize the impact on the evaluations. Tampon component prototype sets containing several alternatives were displayed at designated stations corresponding to each set of components and the participants were asked to observe and handle each alternative prototype as they would normally interact with this type of product. The stations were randomized to prevent bias. One at a time, women were presented with sets of options to consider. The interviews evaluated 8 different sets (one for applicator color, one for pouch material, etc.). The alternatives in each set were identical except for the unique feature difference being evaluated in that particular set at each station. Both the current and conceptual tampons included several exercises, and within each station participants were asked to rank all of the alternatives and to rate each component prototype on a scale of one to one-hundred (1-100). This provided a clear understanding of preference drivers and uniqueness intensity between the options. Following the station exercises, participants were asked to rank and rate on importance each of the eight attribute statements about tampons as seen in FIG. 2. All rankings were recorded in a database to help determine the “importance” of each attribute tested.

Following the evaluation of all sets, a Q-sort of tampon component options was completed based on importance. Following the Q-sort on importance, a modeled-simulation presented a visual on a computer screen of a composite tampon incorporating a woman's first choice tube design options.

### Assimilation of Item Prototypes

As described above, physical product samples were created for each component being evaluated so that the consumer was able to see and feel the product, aiding in discussions focused on functionality and aesthetic appeal. For example, samples were created using various material types, cutters, and adhesive methods, as well as using three-dimensional modeling software and layered rapid-prototyping equipment.

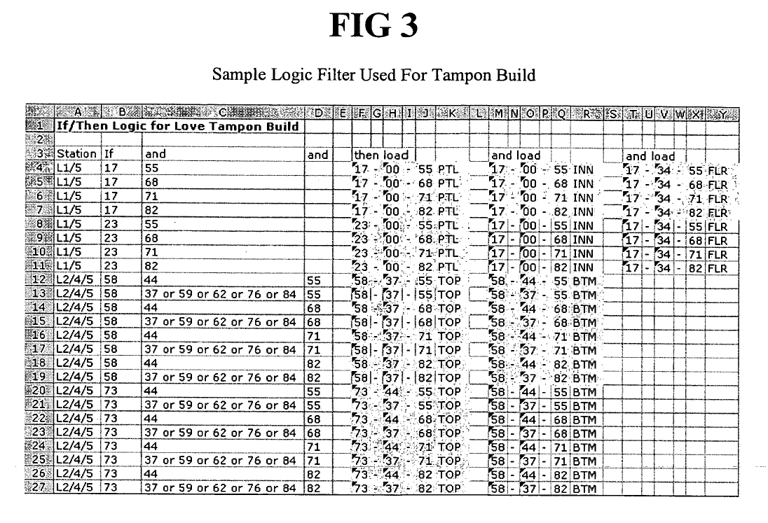

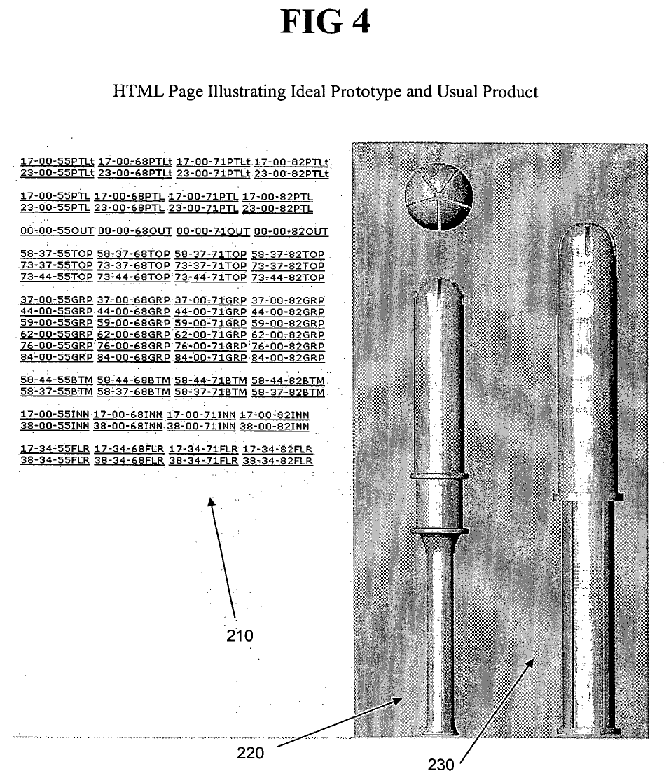

As each participant worked through the various component groups, or “stations”, of the study (each testing a potential product development improvement or variation), preferences were recorded either by means of a facilitator or by the participant entering her selections directly into the software. These preferences were sent through a logic filter, such as displayed in FIG. 3. It can be seen in FIG. 3 that column A lists the stations which affect the variable in question, and columns F-Y are random labelings of the options available in those stations. For example, the first line indicates that if in stations 1 and 5, the participant chose codes 17 and 55, then in order to build a virtual composite image of the ideal item, the files 17-00-55PTL, 17-00-55INN, and 17-34-55FLR were to be loaded. With reference to FIG. 4, these files 210 were then used to create a composite image of each participant's “ideal” item 220 based on selections made for each potential improvement. In addition, each participant's usual brand of tampon 230 was also displayed on the computer screen, as seen in FIG. 4. These two computer visualizations were compared to each other by the participant to understand the appeal of the new tampon prototype and to provide a side-by-side comparison.

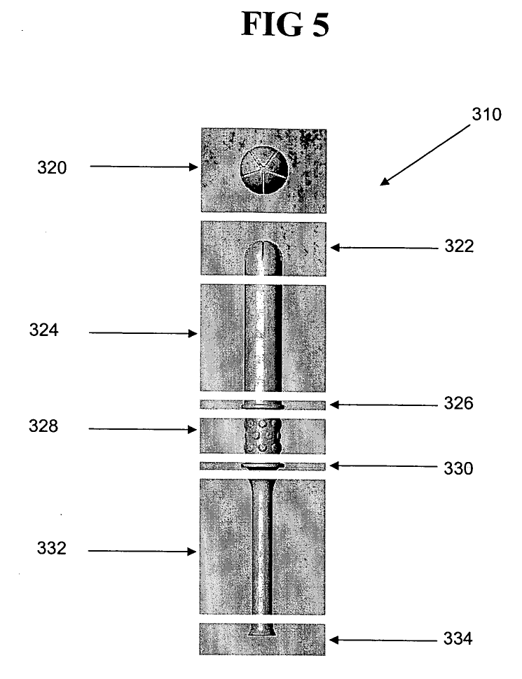

Once the participant made selections at each station and the selections were assimilated through the logic filter, the result was a series of image filenames which together made up the full composite tampon image 220. These files were arranged, using basic HTML code, into the correct order to build the image 220. In other words, the images of FIG. 4 were actually a composite of nine sub-images 310, as seen in FIG. 5. Each sub-image 310 corresponds to a component of the tampon for which the participant evaluated, ranked and rated prototypes by viewing physical representations in accordance with the invention. For example, in an exemplary embodiment, the participant could express a preference for a top view of petals 320, side view of petals 322, an applicator barrel 324, an upper ridge grip 326, a grip area 328, a lower grip ridge 330, a plunger 332, and a plunger flare 334.

Selections and evaluations were made by viewing several physical specimens of each component, and then providing a ranking for each component group. Each ranking was then placed into the software by a facilitator, or directly by the participant, where it assimilated through the logic filter, resulting in image filenames used to display a prototype image of the “ideal” tampon to the participant. Participants were shown (on screen) their ideal tampon prototype (i.e., a virtual modeled-simulation), which was a combination of the participant's highest rated components throughout each of the station exercises. Participants could also view their usual brand of tampon (a comparative product) alongside the ideal tampon prototype.

The participants were then asked to examine their ideal tampon prototype adjacent to the comparative product, as shown in FIG. 4, and to make judgments based on this comparison. The new prototype tampon, which the participant had “built” throughout the study, elicited an emotional response. Additionally, it allowed the participant to easily consider such aspects as aesthetic appeal and ergonomic comfort. Their responses to these questions, along with their responses to each potential product improvement, were collected in a database with the responses of all other participants. Several questions including overall preference and purchase intent were then asked. To conclude the interview, each participant was asked to rank potential new names for the ideal tampon prototype she created.

In general, the resulting information from this single study can be used to determine which product developments are valuable to the consumer and should be pursued.

It will be appreciated that details of the foregoing example, given for purposes of illustration, are not to be construed as limiting the scope of this invention. Although only a few exemplary embodiments of this invention have been described in detail above, those skilled in the art will readily appreciate that many modifications are possible in the examples without materially departing from the novel teachings and advantages of this invention. For example, features described in relation to one example may be incorporated into any other example of the invention.

Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention. As various changes could be made in the above constructions without departing from the scope of the invention, it is intended that all matter contained in the above description shall be interpreted as illustrative and not in a limiting sense.

What is claimed is:

1. A method for rapidly producing a prototype comprising the steps of:
(A) conducting an interview of a participant in a product development study;
(B) presenting an item for review;
(C) providing physical sets of alternatives for components of the item;
(D) eliciting preference values for the alternatives from the participant;
(E) inputting the preference values into a computer software program;
(F) producing a virtual ideal item based on the preference values using the computer software program; and
(G) presenting the virtual ideal item to the participant.

2. The method of claim 1 further comprising the step of using computer programming to pool respondent choices to determine statistical implications.

3. The method of claim 1 further comprising the step of determining the importance of at least one element of the design process.

4. The method of claim 1 further comprising the step of utilizing virtual reality to produce the virtual ideal item.

5. The method of claim 1 further comprising the step of eliciting emotional feedback from the participant.

6. The method of claim 1 wherein the item is modified and displayed to the participant after each decision is made.

7. The method of claim 1 further comprising the step of constructing a physical version of the virtual ideal item.

8. The method of claim 7 wherein the physical version is produced using a rapid prototyping system.

9. The method of claim 1 further comprising the step of comparing the virtual ideal item to a usual item.

10. The method of claim 1 further comprising the step of generating a number of mutations to the item.

11. The method of claim 1 further comprising the step of proposing alternatives for the item in real-time.

12. The method of claim 1 further comprising the step of asking follow-up questions to the participant.

13. The method of claim 1 further comprising the step of obtaining non-verbal feedback from the participant.

14. The method of claim 13 wherein the non-verbal feedback is obtained by a biomonitor.

15. The method of claim 1 further comprising the step of quantitatively correlating the preference values with corresponding predetermined optimum applicability values using a correlation algorithm to calculate an overall or average rating for each alternative.

16. The method of claim 15 wherein the algorithm includes scaling factors.

17. The method of claim 1 further comprising the step of the participant modifying the item.

18. The method of claim 1 wherein the participant is pre-screened.

19. The method of claim 1 wherein the participant is placed into a group based on pre-determined criteria to obtain particular information.

20. The method of claim 1 including computerized systems with multiple participants joined by a network and multimedia marketing research systems.
